(19) United States
(12) Patent Application Publication
(10) Pub. No.: US 2004/0203852 A1
(43) Pub. Date: Oct. 14, 2004

(54) System for delivering location-based notifications and method thereof

(76) Inventor: Pradeep Janakiraman, Tamil Nadu (IN)

Correspondence Address: WELLS ST. JOHN P.S., 601 W. FIRST AVENUE, SUITE 1300, SPOKANE, WA, 99201, US

(21) Appl. No.: 10/126,925

(22) Filed: Apr. 17, 2002

(30) Foreign Application Priority Data
Mar. 7, 2002 (IN) 218/MUM/2002

(51) Int. Cl. H04Q 7/20

(52) U.S. Cl. 455/456.1; 455/458; 455/141

(57) ABSTRACT

A system and method for providing location based notifications, comprising a remote communications device, a communications network and a base station having a notification system. A personalization engine receives user preferences and transfers user information to a user preference repository; a preference profiler retrieves predefined user information from a registry for comparison with the user preferences; the preference profiler notifies a notification monitor and a location monitor of the comparative results; the location monitor retrieves location information from a user location repository and notifies the notification monitor of the location information, the user information, the user preferences and the user location being compared; and a notification gateway notifies the location based notification to the remote communications device.

### 1. FIELD OF THE INVENTION

This invention in general relates to mobile communication technologies. More particularly this invention relates to a system for providing location-based notifications and methods thereof for use in mobile telephone services.

### 2. THE BACKGROUND OF THE INVENTION

There are several value added services that can be made available to subscribers of remote communications devices including mobile phones and other personal digital assistants. One such value added service is to provide location-based information to mobile telephone users. This means notifying the users of mobile phones and other identical hand-held remote communications devices with useful and interesting information, addressed at a variety of topics like places of interest in the vicinity, access to local maps or driving directions. In addition to these, there are services, which notify mobile telephone users from time to time about events within the user's vicinity. Examples of such notifications are advertisements about discount sales, movies playing in the local theatres or contacts of a newly opened food-joint and so on. Location-based notifications thus comprise of information services that the users actively seek, such as local maps and driving directions on the move, and notifications that the users receive from time to time, such as local events.

There exist conventional arts for providing location-based notifications. One such known method involves tracing the user locations using mobile positioning systems from time to time and searching a data repository for proximate events using the user position thus obtained. When matching events are found based on the user-established preferences, notifications are sent to their mobile devices. In accordance with another known method the user provides position to the level of accuracy known by entering it on the mobile device and connecting to the service provider. Once the user position is received, a program works in the background to find out the proximate events and notifies the user. In this approach, the user is expected to explicitly enter the position. Information thus provided could be accurate only to the level that the user is sure about. Also, there is the burden of entering the position from time to time to find out proximate events. This is a highly simplified approach and was one of the earliest towards providing location based information and notifications. A description of this technology is available at http://www.vindigo.com. Once the user tells the software where they are, they can go on to search for local information, which is provided by the software. While in the case of Vindigo, the entire local information resides locally on the client device, it could also be the case that the client has some form of wireless internet connectivity and after entering the current position, the software could connect to a server and present the localized information to the user.

Another known technology in this area provides for methods whereby the network service provider pro-actively searches for the user-locations from time to time. The network service provider makes use of the wireless network hardware and software to trace the user-locations. This is achieved by using specialized hardware and software configured to trace user locations within the wireless operator's network. When a particular device is to be traced wireless signals are sent to the mobile communication device and the responses from the device are collected and analyzed using the specific hardware and software configured for that purpose. Based on this analysis, the mobile devices can be positioned. This technology has been discussed in S. Saltenis, C. Jensen, S. Leutenegger, and M Lopez. “Indexing the positions of continuously moving objects”. ACM SIGMOD International Conference on Management of Data, 2000.

In another known approach the methods of predicting the user's location as a function of certain parameters at a particular instant of time have been employed. This approach predicts the user's current position by taking into account the last known user position, the user's speed of motion, the direction of motion and the time elapsed since the last time the user's position was determined accurately. One well-known problem with this approach is that in a real life scenario the user movements are random in a typical urban city, and thus the speed and direction could vary continuously making it very tough to accurately predict a future location where the user could be based on the above criteria. The probability of error in the prediction can be high. Also the resources required to compute such predictive functions for a large number of users are enormous. Thus, the known approaches to this problem have ranged from the simplest and rudimentary to mathematical and algorithmic and sometimes costly solutions. Some of the above referenced technologies are described in K Lam, O. Ulusoy, T. S. H. Lee, E. Chan, G. Li, “An Efficient Method for Generating Location Updates for Processing of Location-Dependent Continuous Queries” and O. Wolfson, A. P. Sistla, S. Chamberlain, and Y. Yesha. Updating and querying databases that track mobile units invited paper, special issue of the Distributed and Parallel Databases Journal on Mobile Data Management and Applications, 7(3):257--287,1999.

A major deficiency of the above technologies is the heavy toll on the system's computing resources as the number of subscribers of the service increases, in tracing the user positions, applying the associated user preferences, searching for matching events and sending notifications. Typically for a wireless carrier with over a million subscribers, when the user locations would have to be constantly tracked in every 5 minutes about events within a specified range, the user locations would have to be pinged and sorted about a 1,000,000,000,000 (trillion) times in a year to achieve the functionality.

Additionally, since the users are tracked continuously, it is possible that users are constantly bombarded with a lot of notifications, which may sometimes be out of context. For example, when a user might be attending a funeral it is possible that a notification about a discount sale in a pub is sent which could be socially out of context. Also there are times when users would not liked to be traced, or in other words would not like someone to know where they are. The ability of users to express such preferences and coupling these with the provisioning of location-based services have not been adequately addressed in the known methods. Because users may pay a price to receive such services, it is highly desirable that the user experience is enhanced and made more relevant by taking into account the personal preferences of the users to reduce dissatisfaction.

### 3. SUMMARY OF THE PRESENT INVENTION

The invention provides for a system for location based notifications. The system comprises a remote communications device configured to communicate through a telecommunication network, a base station in communication with the remote communications device, the base station having a notification system interfacing with the remote communications device, wherein the system is configured to provide location based notifications using the notification system.

Another aspect of the invention provides for a system for delivering location based notifications, the system comprising a remote communications device configured to communicate through a telecommunications network, a base station in communication with the remote communications device, the base station having a personalization engine configured to interface with the remote communications device and receive personal preferences from the remote communications device, a user preference repository configured to store personal preferences obtained by the personalization engine from the remote communications device upon termination of the interface between the remote communications device and the personalization engine, a registry configured to receive and store predefined user information, a preference profiler configured to receive user preferences from the user preference repository and user information from the registry, a location monitor configured to obtain notifications of user preferences from the preference profiler, a location gateway interfacing with a positioning server to receive location information, a user location repository configured to receive and store location information from the location gateway, a notification monitor configured to obtain notifications from the preference profiler and to receive location information from the location monitor, a notification gateway configured to notify the remote communications device with location information and wherein the personalization engine upon receipt of user preferences transfers the user information to the user preference repository, the preference profiler retrieves from the registry predefined user information stored therein and compares with the user preferences received from the user preference repository, the preference profiler notifies the notification monitor and the location monitor the results thereof, the location monitor retrieves location information stored in user location repository and notifies the notification monitor of the location information, the user information, the user preferences and the user location being compared, the notification gateway notifies the location based notification to the remote communication device.

In yet another aspect the invention provides for a location based notification system wherein the personalization engine is configured to receive and identify preferences provided by the remote communications device and send the preferences to the user preference repository, the preferences with respect to service, frequency, range and enablement of tracing user.

In still another aspect the invention provides for a location based notification system wherein a preference profiler comprises a task scheduler configured to identify whether the user has enabled tracing option. The system further comprises a user profiler having an information scheduler configured to obtain latest personalization details from the user preference repository. Also part of the system is a user profiler comprising a notification scheduler configured to obtain notification frequency of the remote communications device. It is further a component of the system to have a registry configured to store user information. The preference profiler of the system is configured to receive user information from the registry. The system also comprises a location monitor configured to interface with the location gateway and obtain location information and stores the location information in the user location repository. The system comprises a location update scheduler configured to optimally update location of the remote communications device and the notification monitor comprises a task comparer configured to compare user information with user preferences. The system further has a notification monitor comprising a frequency identifier configured to estimate the notification frequency set for the identified mobile communications device and a notification monitor configured to interface with the notification gateway which in turn sends out the location based messages to the remote communications device.

It is also an aspect of the current invention to provide for a method for providing location based notifications; the method comprising receiving user preferences by a personalization engine from a mobile communications device, identifying the user preferences and storing the same in a user preferences repository for periodic retrieval, compiling and storing user information in a registry, retrieving user information from the registry and comparing the same with the user preferences retrieved from the user preference repository by a preference profiler, notifying a location monitor and a notification monitor with the user preferences and the user information by the preference profiler, receiving location information by a location gateway and storing the location information in a user location repository, retrieving location information from the user location repository by the location monitor and notifying the notification monitor with the location information, comparing the user information, the user preferences and the location notifications by the notification monitor and identifying user preferred location based information and sending the same to a notification gateway, providing the user preferred location based notification by the notification gateway to the remote communication device.

One aspect of the invention relates to provisioning automatic notifications from time to time to the mobile users based on their location and based on preferences that are established and set up by the user with a personalization system of the service provider. This aspect does not however depend on the nature of positioning algorithms or the hardware or software for tracing the locations of mobile devices. Effective user profile personalization solutions help in delivery of highly targeted products and services by deeply understanding what is important to each customer and why, and by facilitating instant product or service understanding and adoption by bridging the gap between customer preferences and product attributes

This approach arms customers with the options that make more sense for them. The end result is better customers, customers better equipped with the right information, more satisfied and more determined to act-buy. For online merchants, this translates into increased sales, sales per customer, and customer loyalty over time. By taking user preferences into account, the tracing of user locations and dispatching of notifications can be done selectively, thereby reducing the overload on the system resources. This also results in significant reduction of costs for the service provider.

### 4. BRIEF DESCRIPTION OF THE DRAWINGS

The present invention would be better understood by referring to the drawings wherein:

FIG. 1 is a block diagram illustrating a system, including a base station and remote communication devices, embodying the invention.

FIG. 2 is a block diagram illustrating in detail the components of the base station of FIG. 1 including a notification system having a notification monitor, a location monitor, a preference profiler, a location gateway, a notification gateway, and a personalization engine.

FIG. 3 is a schematic diagram depicting the remote communications device of FIG. 1 interacting with the personalization engine of FIG. 2 to set up personalization profile. FIG. 3 additionally illustrates the components of the preference profiler of FIG. 2.

FIG. 4 is a block diagram illustrating the components of the notification system of FIG. 2, and a location update scheduler coupled to the location monitor, wherein the notification monitor of FIG. 2 interfaces with the preference profiler of FIG. 2. The location monitor and the notification monitor further interface with the location gateway and the notification gateway of FIG. 2.

FIG. 5 is flow chart illustrating the method of operation of the preference profiler of FIG. 2.

FIG. 6 is flow chart illustrating the method of operation of the preference profiler of FIG. 2 wherein the preference profiler comprises a user information scheduler.

FIG. 7 is flow chart illustrating operation of a notification scheduler as comprised in a preference profiler.

FIG. 8 illustrates a task-schedule flow chart for the notification monitor of FIG. 2 showing when positions of devices should be updated.

FIG. 9 is logical flow chart that illustrates method applied to the notification monitor.

FIG. 10 and FIG. 11 are logical flow charts that illustrate a method that is performed by the location monitor and the location update scheduler of FIG. 4.

FIG. 12 is a task schedule table illustrating one of the services provided by the system.

FIG. 13 is a task schedule table illustrating the method for determining device positions.

FIG. 14 is a table illustrating a notification schedule table for a given user.

FIG. 15 is a table illustrating user positions along with time stamp of current updates.

FIG. 16 is a user preference table illustrating various services.

### 5. DETAILED DESCRIPTION OF THE PREFERRED EMBODIMENTS

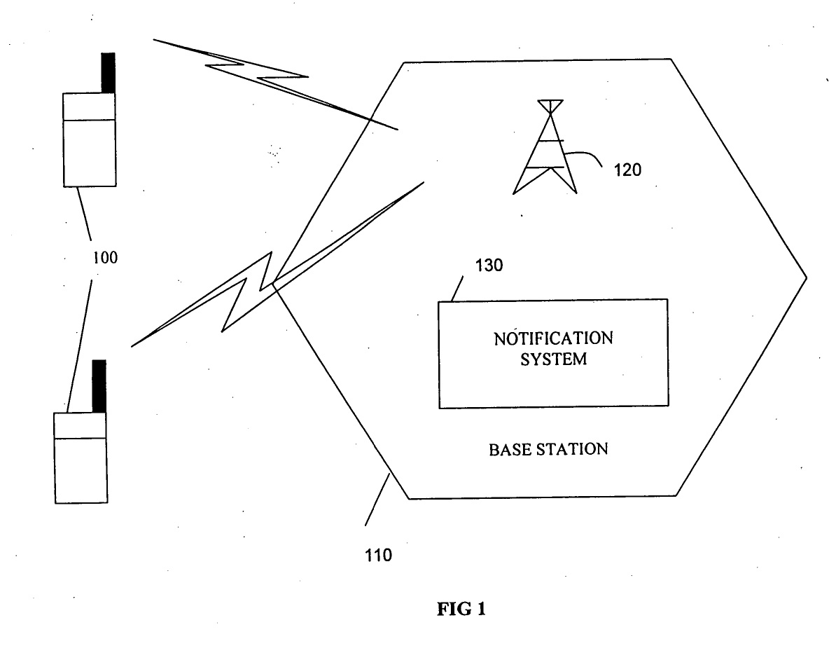

FIG. 1 illustrates a system including a remote communications device 100, and a base station 110. The remote communications device 100 interacts with the base station 110 through a communication network 120. The base station 110 comprises a notification system 130, which interfaces with inputs from the remote communications device 100.

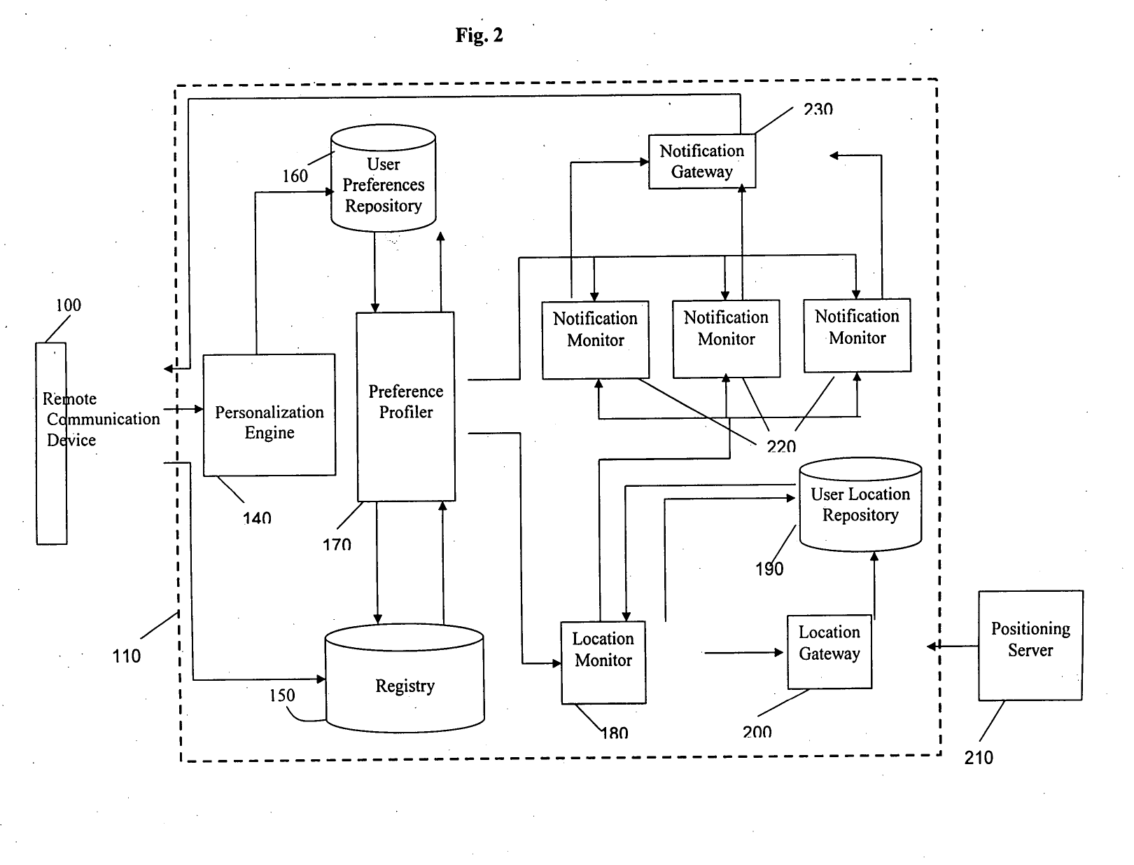

FIG. 2 illustrates in more detail the various components of the notification system 130 and the interactions of each of the components therein. A user of the remote communication device 100 interfaces with the personalization engine 140 via the remote communication device 100. The personal preferences provided by the remote communications device 100 are then stored into the user preferences repository 160. After the remote communications device 100 finishes interaction with the personalization engine 140, the personal preferences are stored in the user preference repository 160. Preference profiler 170 notifies the user preferences which are selectively identified against a given device holder to the location monitor 180. The preference profiler 170 also notifies the selectively identified user preferences to notification monitor 220. The preference profiler 170 retrieves, from the registry 150, predefined user information stored therein and compares the same with the user preferences retrieved from the user preference repository 160 before it notifies the notification monitor 220 and the location monitor 180. The location gateway 200 interfaces with the positioning server 210 to receive location information, which is temporarily stored in the user location repository 190. The location information thus stored in the user location repository 190 is then passed on to the notification monitor 220 by the location monitor 180. The notification gateway 230 interfaces with the remote communications device 100 and sends out location based notifications to the remote communications device 100.

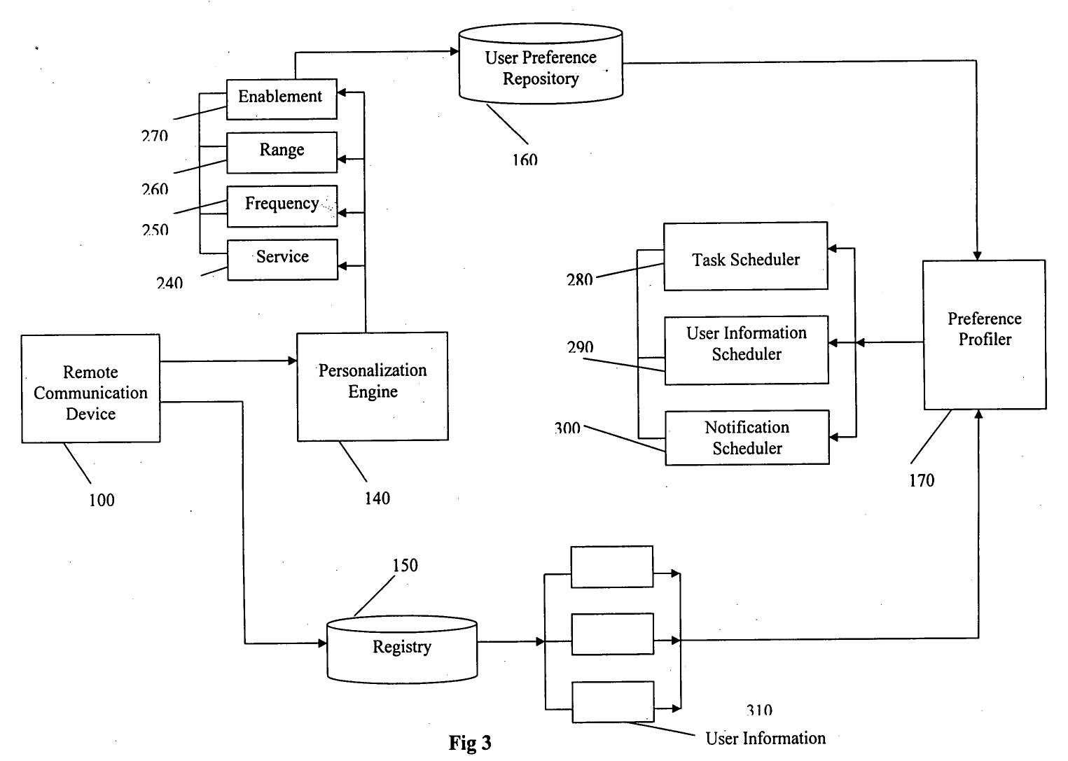

FIG. 3 illustrates the components of the base station wherein the personalization engine 140 interfaces with the remote communications device 100 and the personal preferences thus received are stored in a user preference repository 160. The personalization engine 140 processes the user preferences based on predetermined choices of preferences including preferences with respect to service 240, frequency 250, range 260 and enablement 270. When the remote communications device 100 interacts with the personalization engine 140, the remote communications device 100 enters the notification frequency 250 and the enablement 270 for each subscribed service 240. The notification frequency 250 is the rate at which the remote communications device 100 would be notified when there are matching events based on the remote communications devices' 100 most recent position. The enablement 270 determines whether the remote communications device 100 wishes to receive notifications from that particular service 240 or not. The remote communications device 100 also indicates the maximum range 260, which should be used to match the remote communications device' 100 position while delivering notifications. The remote communications device 100 would be sent a notification by a service 240 if the remote communications device' position falls within this range 260. This could be a few hundred meters or a zip-code which has been entered into the remote communications device 100, accordingly. The user preferences thus stored in the user preference repository 160 is retrieved by preference profiler 170. The preference profiler 170 comprises a task scheduler 280 configured to identify whether the remote communications device 100 has chosen enablement to notify 270. The user information scheduler 290 is configured to obtain latest personalization details from the user preference repository160 and a notification scheduler 300 is configured to obtain notification frequency 250 of remote communications device 100. The preference profiler 170 obtains user information from the registry 150, wherein the registry 150 stores user information 310.

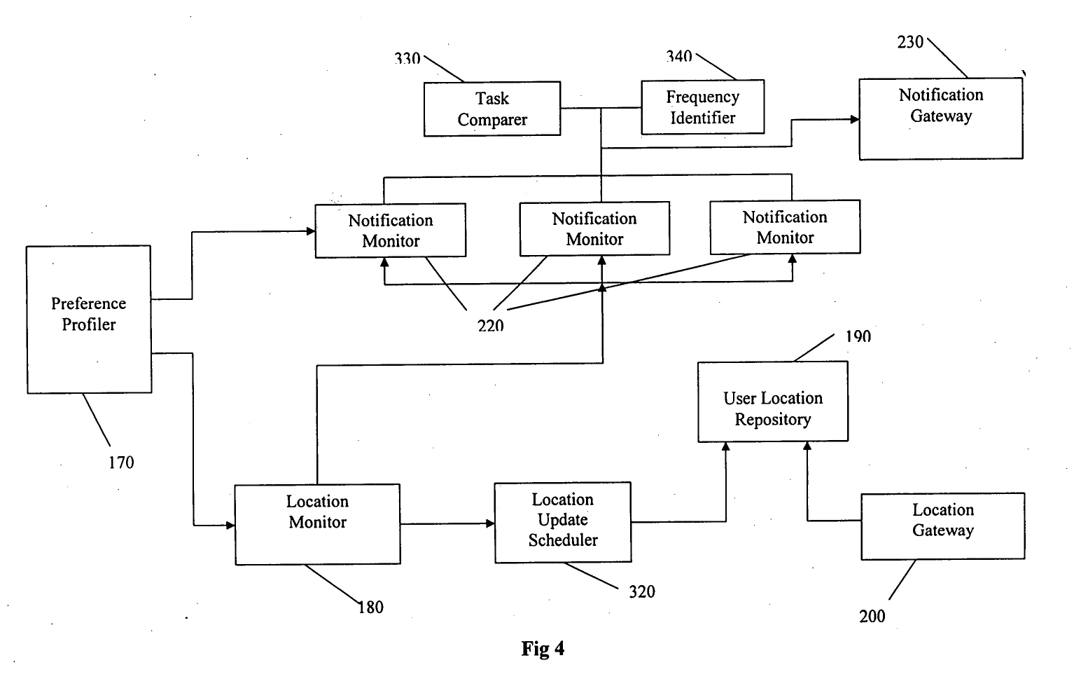

FIG. 4 illustrates the preference profiler 170 interacting with location monitor 180 and notification monitor 220. The location monitor 180 interfaces with the location gateway 200 and obtains location information which is stored in user location repository 190. The location monitor 180 also comprises a location update scheduler 320 configured to optimally update the location of the remote communications device 100. The location monitor 180 interfaces with the notification monitor 220. The notification monitor 220 comprises a task comparer 330 which compares user information with user preferences, and a frequency identifier 340 which estimates the notification frequency 250 set for the identified remote communications device. The notification monitor 220 interfaces with the notification gateway 230 which in turn sends out the location based messages to the remote communications device 100.

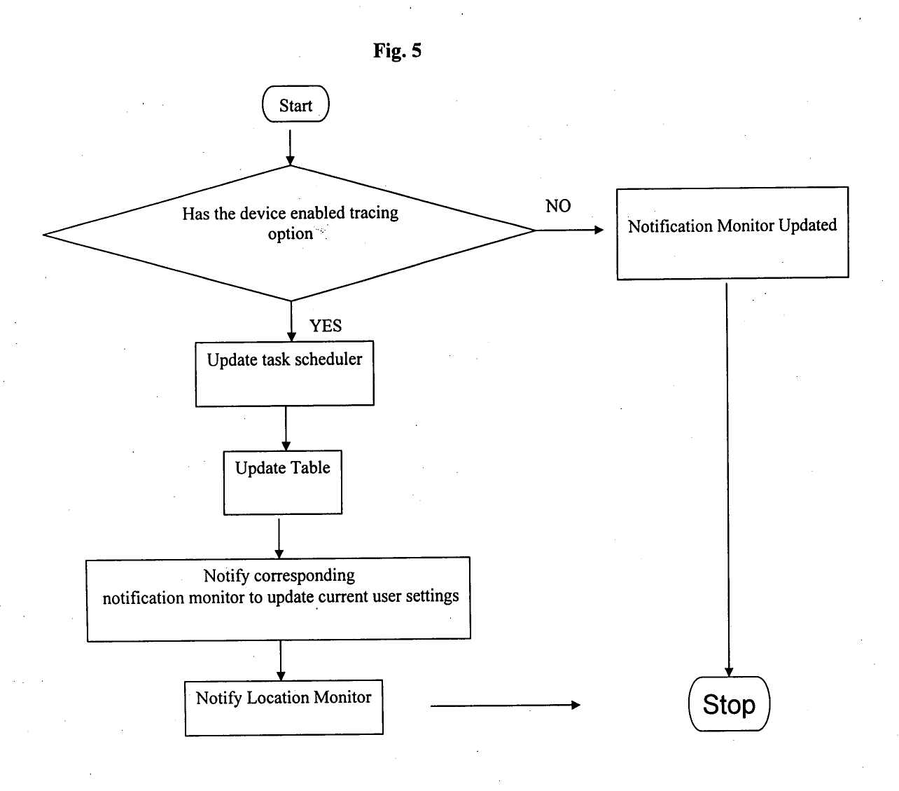

FIG. 5 is a flow chart illustrating the method of operation of the preference profiler 170. The task scheduler 280, upon receipt of user request for disablement of tracing, notifies the notification monitor 220 accordingly and the notification monitor 220 removes the remote communications device 100 from the current list of users to be notified. The preference profiler 170 comprises a task scheduler 280 for each remote communications device 100 based on the respective preferences set for receiving notifications from the subscribed services 240. The task scheduler 280 maintains the preference information in the form of tables. These tables contains a list of services 240 from which the remote communications device 100 is scheduled to receive notifications at pre-set time intervals chosen by the user remote communications device, when the remote communications device 100 is within a specific range 260 of that service. The preference profiler 170 employs the task scheduler 280 to updates these tables as, for example, when a remote communications device 100 makes changes to personalization settings by interacting with the user personalization engine 140. The task scheduler 280 can be utilized to determine how many services 240 are expected to notify the remote communications device 100 at a particular time slot, wherein the location monitor 180 is notified accordingly.

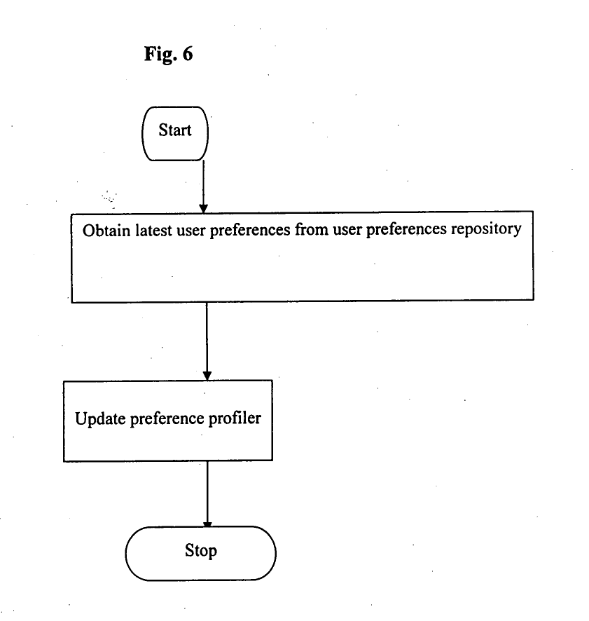

FIG. 6 is a flow chart illustrating the method of operation of the preference profiler 170 wherein the preference profiler 170 comprises a user information scheduler 290, which obtains the latest personalization details from the user preference repository 160.

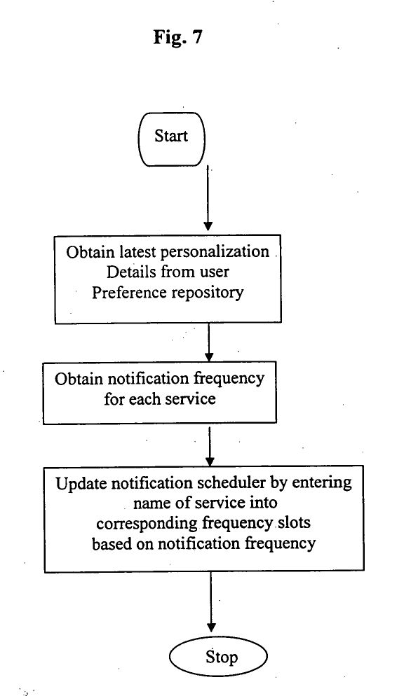

FIG. 7 illustrates a method performed by the preference profiler 170. The notification scheduler 300 obtains the notification frequency 250 of the remote communications device 100. Based on the frequency 250, the notification scheduler 300 updates the user preference and notifies the notification monitor 220 accordingly.

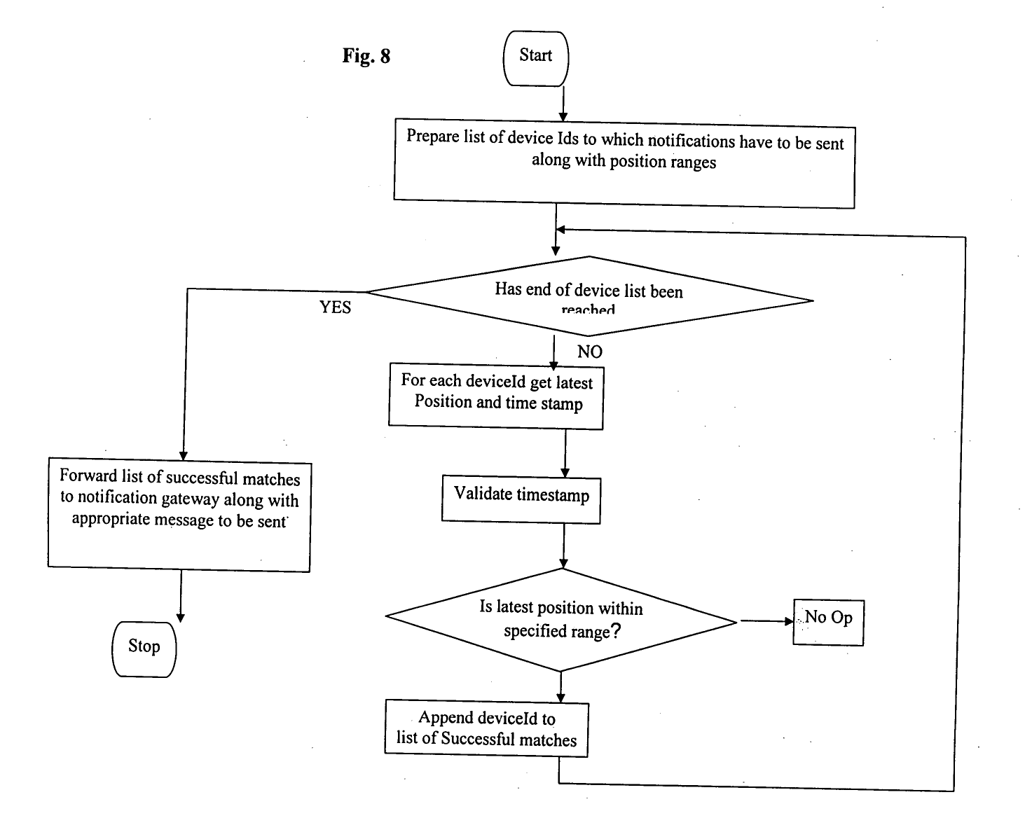

FIG. 8 is a flow chart illustrating the method performed by the notification monitor 220. The notification monitor 220 comprises a task comparer 330 which compares user information with user preferences and location information. The task comparer 330 prepares a list of device identification information based on the user information maintained by the user information scheduler 290 and obtains user position and time stamp, validates the time stamp 350 and determines whether the remote communications device 100 is within the specified range 260. The task comparer 330 then compares the user information and user preferences and forwards a list of successful matches to notification gateway 230.

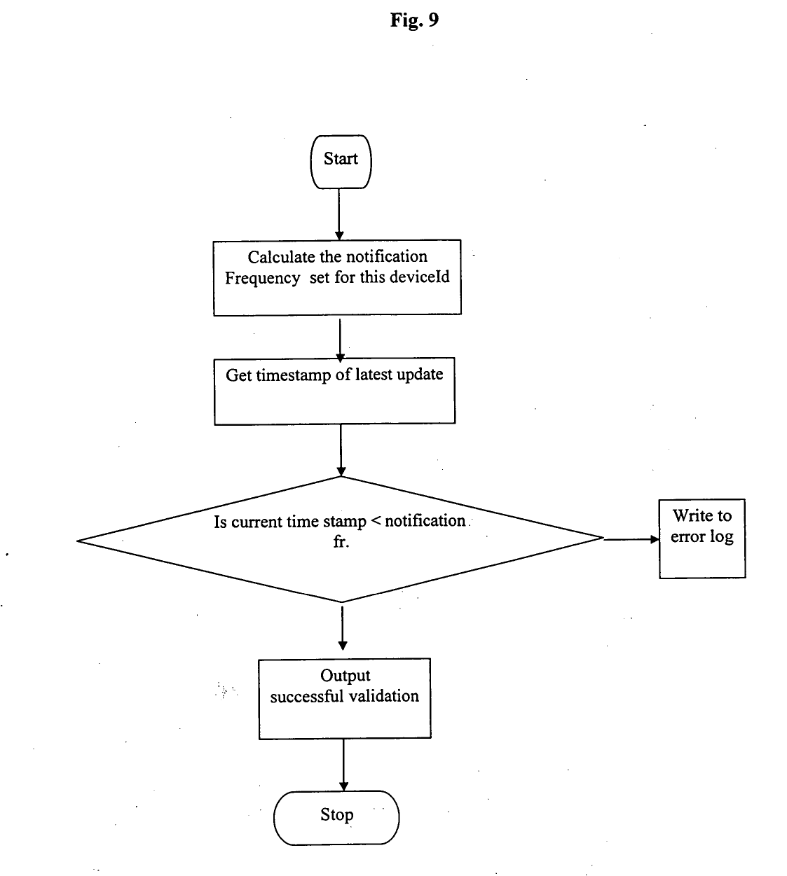

FIG. 9 illustrates a method by which the notification monitor 220 operates. The notification monitor 220 comprises a frequency identifier 340 which estimates the notification frequency set for an identified user. Employing the user information the frequency identifier340 obtains the time stamp 350 and determines the notification frequency set for the corresponding remote communications device 100.

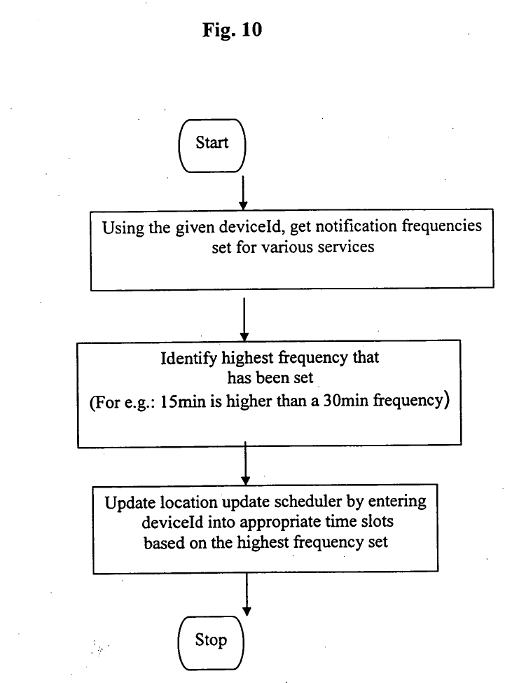

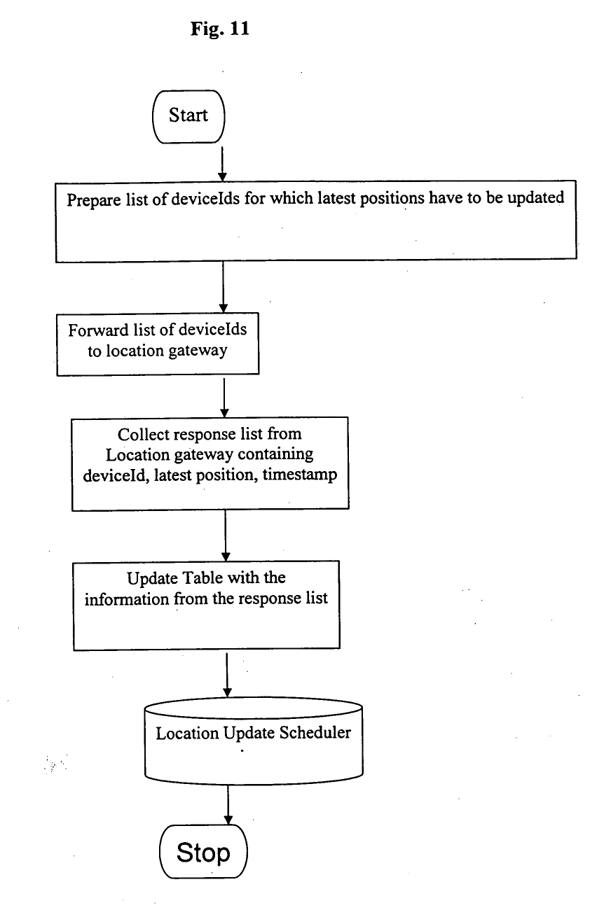

FIG. 10 and 11 illustrate how the location monitor 180 operates. The location update scheduler 320 obtains a list of user information for which user positions have to be updated. The list of user information is forwarded to the location gateway 200. The location update scheduler 320 obtains a time stamp 350 and user position from location gateway 200. Location monitor 180 then updates the user location repository 190.

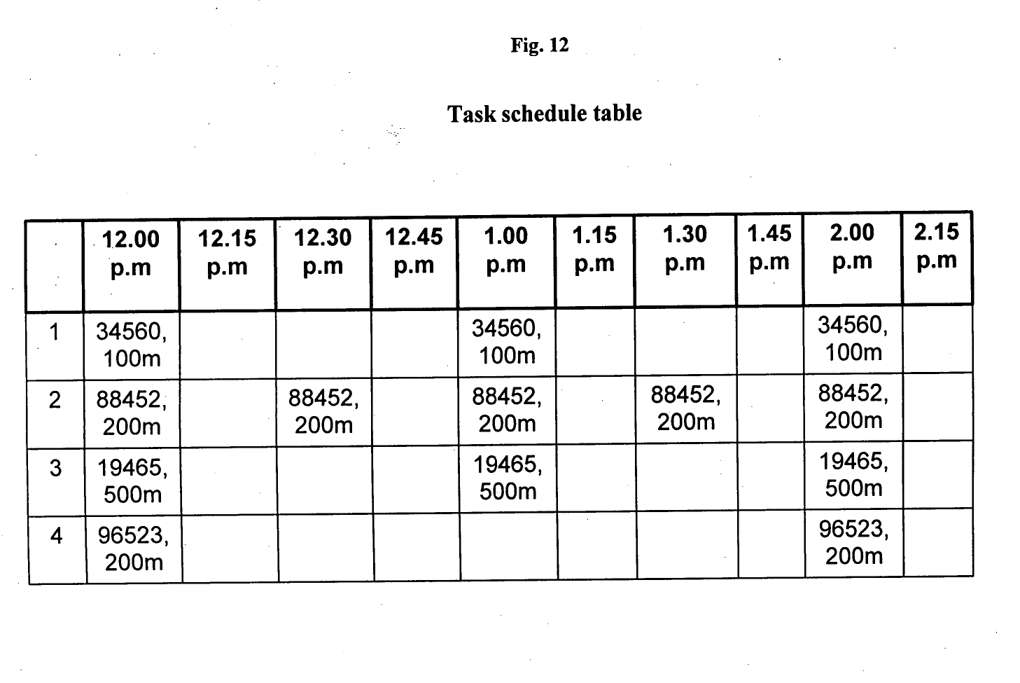

FIG. 12 is a task schedule table illustrating one of the services provided by the system. The table contains device ids and corresponding threshold range that needs to be checked before a given device is sent a notification at a particular slot of execution. The notification monitor 220 is configured to perform this function.

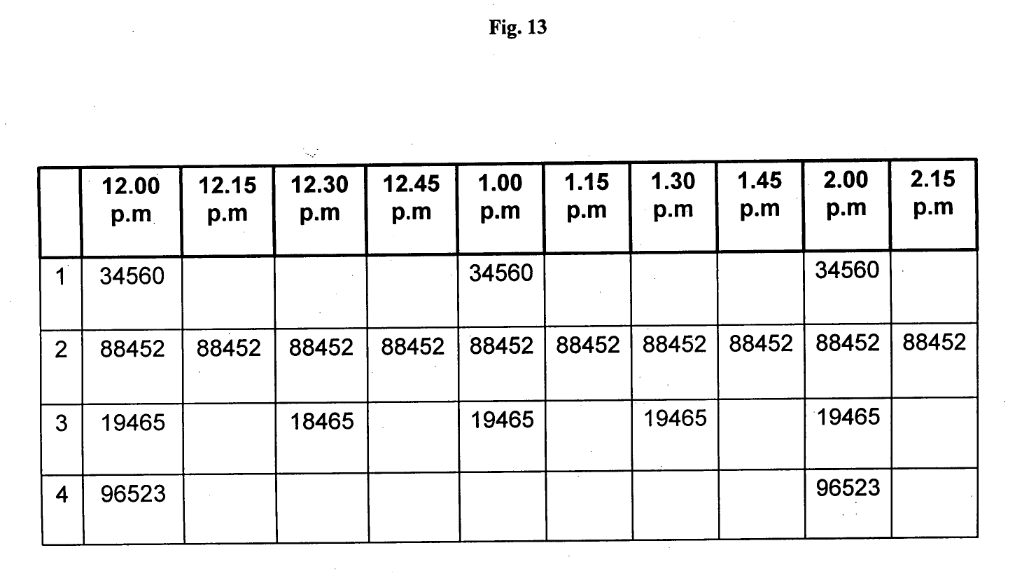

FIG. 13 is a task schedule table illustrating the method for determining device positions. This task schedule table illustrates a method whereby the notification frequencies 250 set for various services 240 are obtained using device ids. The highest frequency that has been set is then identified. The device id of the user is then entered into appropriate time slots based on chosen levels of frequency. To further illustrate, the time slots based on the frequency could be intervals of 15 minutes, 30 minutes or 60 minutes. The table illustrates a time slot of 15 minutes.

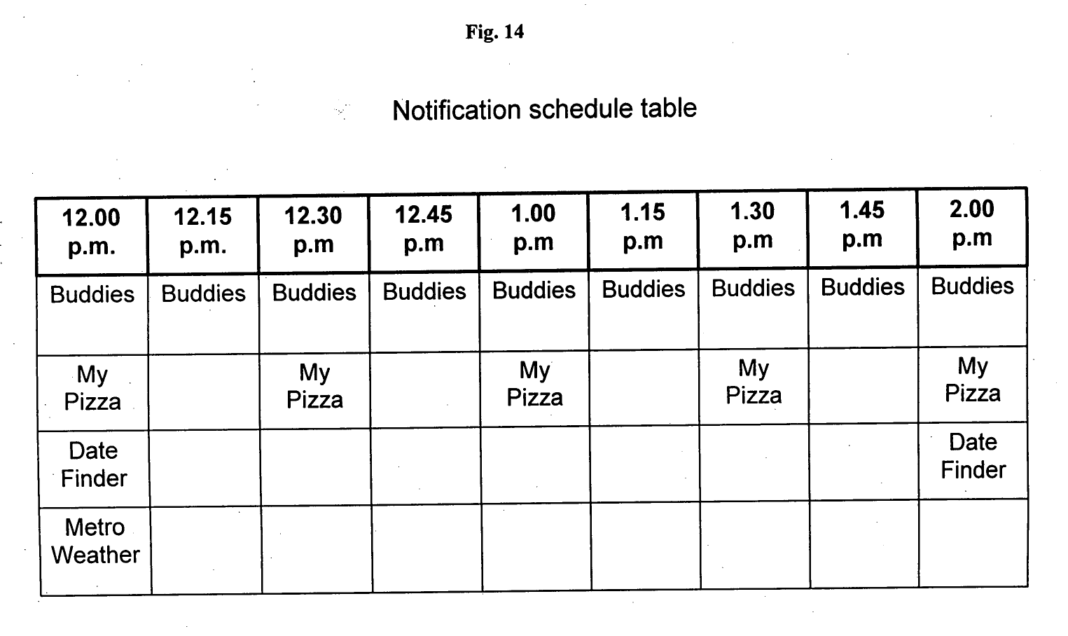

FIG. 14 is a table illustrating a notification schedule table for a given user. This task schedule table is maintained by preference profiler 170 for each user based on the preferences set by the user for receiving notifications in respect of subscribed services 240. The table illustrates the list of services 240in respect of which the user is scheduled to receive notifications at pre-set time intervals chosen by the user. The preference profiler 170 updates as and when the user makes changes to personalization settings through the personalization engine 140.

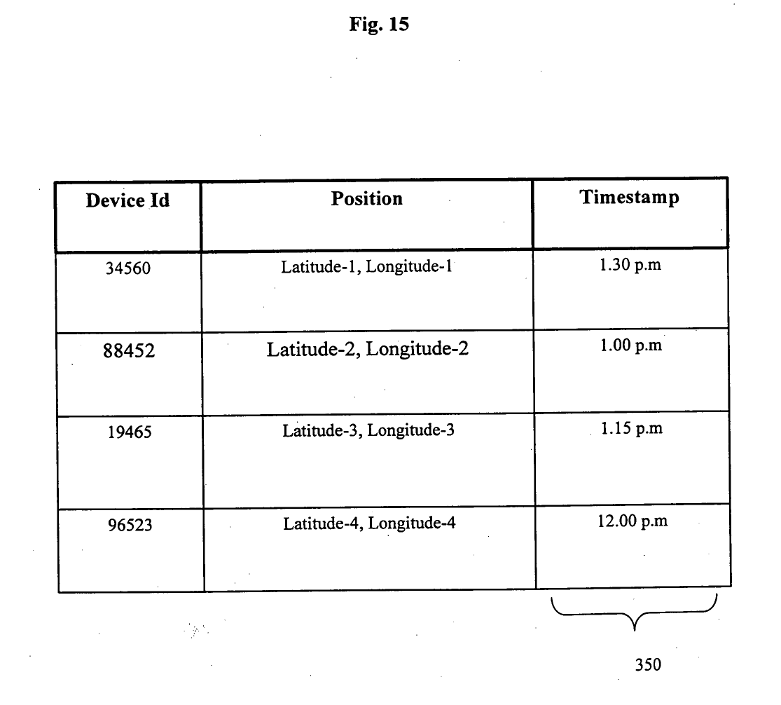

FIG. 15 is a table illustrating user positions alongwith time stamp of current updates as maintained in the user location repository 190. This table contains the latest position of the remote communication devices 100 alongwith timestamp 350 indicating when the position of the device was last determined.

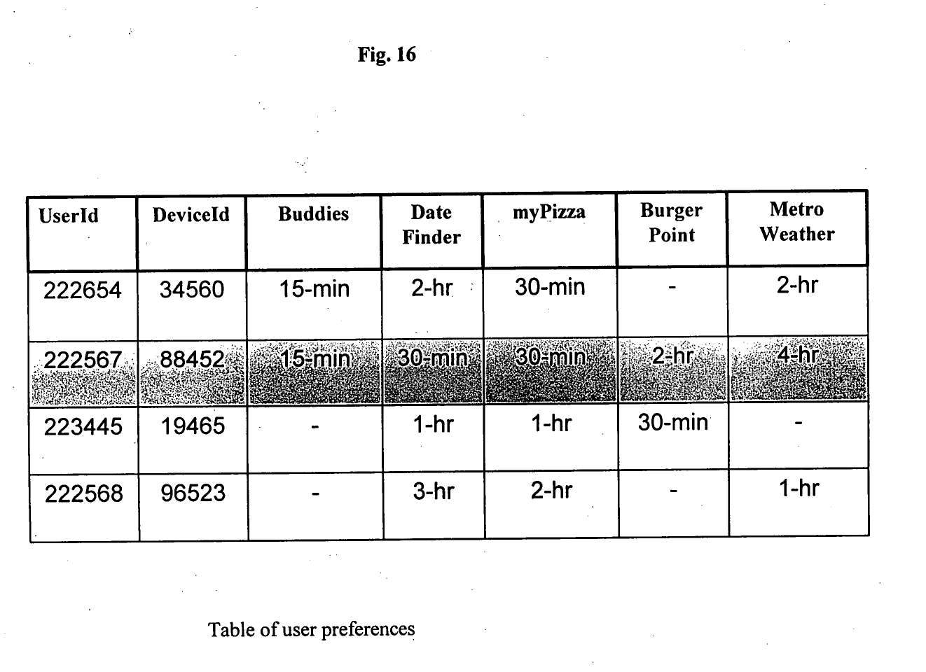

FIG. 16 is a user preference table illustrating various services. The preference details of user are highlighted. The table illustrates the preferences set by the user as against the time slots for receiving notifications in respect of the services chosen.

What is claimed is:

1. A communication system comprising:
a remote communications device configured to communicate through a telecommunication network;
a base station in communication with the remote communications device, the base station having a notification system interfacing with the remote communications device, wherein the base station is configured to provide location based notifications to the remote communication device using the notification system.

2. The system according to claim 1 wherein the remote communications device comprise a mobile phone.

3. The system according to claim 1 wherein the remote communications device comprise any device capable of communicating through a telecommunications device.

4. The system according to claim 1 wherein the base station is configured to provide location based notifications to the remote communications device.

5. A system for providing location based notifications, the system comprising:
a remote communications device configured to communicate through a telecommunications network; and
a base station in communication with the remote communications device, the base station having:
a personalization engine configured to interface with the remote communications device and receive personal preferences from the remote communications device;
a user preference repository configured to store user preferences obtained by the personalization engine from the remote communications device upon termination of the interface between the remote communications device and the personalization engine;
a registry configured to receive and store predefined user information;
a preference profiler configured to receive user preferences from the user preference repository and user information from the registry and to create notifications;
a location monitor configured to obtain notifications of user preferences from the preference profiler;
a location gateway interfacing with a positioning server to receive user location information;
a user location repository configured to receive and store the user location information from the location gateway;
a notification monitor configured to obtain notifications from the preference profiler and to receive location information from the location monitor; and
a notification gateway in communication with the remote communications device, wherein the personalization engine upon receipt of user preferences transfers the user information to the user preference repository, the preference profiler retrieves from the registry predefined user information stored therein and compares with the user preferences received from the user preference repository, the preference profiler notifies the notification monitor and the location monitor the results thereof, the location monitor retrieves location information stored in the user location repository and notifies the notification monitor of the user location information, the user information, the user preferences and the user location being compared, the notification gateway notifies the location based notification to the remote communication device.

6. The system according to claim 5 wherein the personalization engine is configured to receive and identify user preferences provided by the remote communications device and send the preferences to the user preference repository.

7. The system according to claim 5 wherein the personalization engine is configured to receive and identify user preferences with respect to service.

8. The system according to claim 5 wherein the personalization engine is configured to receive and identify user preferences with respect to frequency.

9. The system according to claim 5 wherein the personalization engine is configured to receive and identify user preferences with respect to range.

10. The system according to claim 5 wherein the personalization engine is configured to receive and identify user preferences with respect to enablement of tracing user.

11. The system according to claim 5 wherein the preference profiler comprises a task scheduler configured to identify and store tracing option.

12. The system according to claim 5 wherein the user profiler comprises an information scheduler configured to obtain latest personalization details from the user preference repository.

13. The system according to claim 5 wherein the user profiler comprises a notification scheduler configured to obtain notification frequency of the remote communications device.

16. The system according to claim 5 wherein the location monitor is configured to interface with the location gateway and obtain location information and stores the location information in the user location repository.

17. The system according to claim 5 wherein the location monitor comprises a location update scheduler configured to optimally update the location of the remote communications device.

18. The system according to claim 5 wherein the notification monitor comprises a task comparer configured to compare user information with user preferences.

19. The system according to claim 5 wherein the notification monitor comprises a frequency identifier configured to estimate a frequency opted by a user of the remote communications device.

20. The system according to claim 5 wherein notification monitor is configured to communicate with the notification gateway which in turn sends out location based notifications to the remote communications device.

21. A method for providing location based notifications; the method comprising:
receiving user preferences by a personalization engine from a mobile communications device, identifying the user preferences and storing the user preferences in a user preferences repository for periodic retrieval, compiling and storing user information in a registry, retrieving user information from the registry and comparing the user information with the user preferences retrieved from the user preference repository by a preference profiler, notifying a location monitor and a notification monitor with the user preferences and the user information using the preference profiler, receiving location information by a location gateway and storing the location information in a user location repository, retrieving location information from the user location repository by the location monitor and notifying the notification monitor with the location information, comparing the user information, the user preferences and the location notifications using the notification monitor and identifying and sending the user preferred location based information to a notification gateway, and providing the user preferred location based notification using the notification gateway.

22. The method according to claim 21 wherein the method comprises configuring the remote communications device to select whether or not to receive the user preferred location based notifications.
